(19) United States
(12) Patent Application Publication
(10) Pub. No.: US 2002/0040929 A1
(43) Pub. Date: Apr. 11, 2002

(54) Interactive playing/trading card system

(76) Inventor: Robert Bramucci, Ile Bizard (CA)

Correspondence Address: MEREK & VOORHEES, PATENT, TRADEMARK & COPYRIGHT LAW, 673 South Washington Street, Alexandria, VA, 22314, US

(21) Appl. No.: 09/964,855

(22) Filed: Sep. 28, 2001

(30) Foreign Application Priority Data
Sep. 29, 2000 (CA) 2,321,424

(51) Int. Cl. G06K 7/00

(52) U.S. Cl. 235/435

(57) ABSTRACT

An interactive playing/trading card system is described herein. This system includes a plurality of encoded cards, a controller, a card reader, memory and an output device. Information relating to the nature of the card is provided on each card to allow its identification by the card reader. Once this data is supplied to the controller, the corresponding portion of the memory may be accessed to be transferred to the output device to provide user interactivity.

### FIELD OF THE INVENTION

The present invention relates to playing and trading cards. More specifically, the present invention is concerned with an interactive playing/trading card system including a card reader assembly configured to read information on specially marked or encoded playing cards.

### BACKGROUND OF THE INVENTION

The playing/trading card business is a market that has been profitable in a variety of fields, such as sports, entertainment, environment, and even in relation to public personalities. Nevertheless, even though the market of playing/trading cards has been active for a number of years, new developments in computer and video games are arguably endangering the playing card industry.

Indeed, the current cardboard cards industry doesn't necessarily guarantee the capacities to sustain fascination so as to feed the imagination of tomorrows' children. The traditional card collecting and trading card games business is facing a questionable future. The proliferation of interactive audio and video games for the youth market is an obvious incentive to expand the opportunities that card games can offer.

The conventional mainstream business is the business of playing/trading card games, i.e., games that are portable and social, consisting in a product that can be touched and manipulated, and also in a product that has emotional and trading value.

Recently, on the one hand, developments in several interactive technologies have intensified and are extending towards more challenging expectations and requests. Meanwhile, on the other hand, playing/trading cards have kept relying on the same low technology. Interestingly, however, new technologies have not been that detrimental to the playing/trading card business, as testified by the commercial success of new adventure card games, such as “Magic The Gathering®”.

### OBJECTS OF THE INVENTION

An object of the present invention is therefore to provide an improved interactive playing/trading card system.

### SUMMARY OF THE INVENTION

More specifically, in accordance with the present invention, there is provided an interactive card system comprising:

at least one card provided with encoded data;

a card reader assembly including:

a controller;

a card reader connected to said controller; said card reader being configured to decode the data provided on said at least one card;

memory associated with said controller; said memory being configured to store data relating to said at least one card;

an output device connected to said controller;

wherein said controller is so configured that when the encoded data of one of said at least one card is decoded by said card reader, a corresponding portion of said memory is accessed by said controller and is supplied to said output device.

According to another aspect of the present invention, there is provided a card reader assembly to read encoded data provided on a card; said assembly comprising:

a controller;

a card reader connected to said controller; said card reader being configured to decode the data encoded on a card;

memory associated with said controller; said memory being configured to store data relating to said card;

an output device connected to said controller;

wherein said controller is so configured that when the encoded data of a card is decoded by said card reader, a corresponding portion of said memory is accessed by said controller and supplied to said output device.

According to a final aspect of the present invention, there is provided a An interactive card system comprising:

at least one card provided with encoded data;

a card reader assembly including:

controlling means;

card reading means connected to said controlling means; said card reading means decoding the data provided on said at least one card;

memory associated with said controlling means to store data relating to said at least one card;

output means connected to said controlling means;

wherein said controlling is so configured that when the encoded data of one of said at least one card is decoded by said card reading means, a corresponding portion of said memory is accessed by said controlling means and supplied to said output means.

Other objects, advantages and features of the present invention will become more apparent upon reading of the following nonrestrictive description of preferred embodiments thereof, given by way of example only with reference to the accompanying drawings.

### BRIEF DESCRIPTION OF THE DRAWINGS

In the appended drawings:

FIG. 1 is a schematic block diagram view illustrating a card reader system according to an embodiment of the present invention;

FIG. 2 is a schematic view illustrating a playing/trading card provided with a bar code printed on its lower peripheral portion;

FIG. 3 is a schematic view illustrating a playing/trading card similar to the card illustrated in FIG. 2 but provided with a color code printed on its lower peripheral portion using so called “invisible ink”; and

FIG. 4 is a schematic view illustrating a playing/trading card similar to the card illustrated in FIG. 2 but provided with a microchip.

### DESCRIPTION OF THEE PREFERRED EMBODIMENT

In a nutshell, the present innovation consists in a card reader system configured to detect a code provided on playing/trading cards, and to provide interactive features based on the recognition of the specific card used.

Advantageously, the encoding on the playing/trading card is such that the final look of the card is essentially similar or identical to that of conventional playing cards.

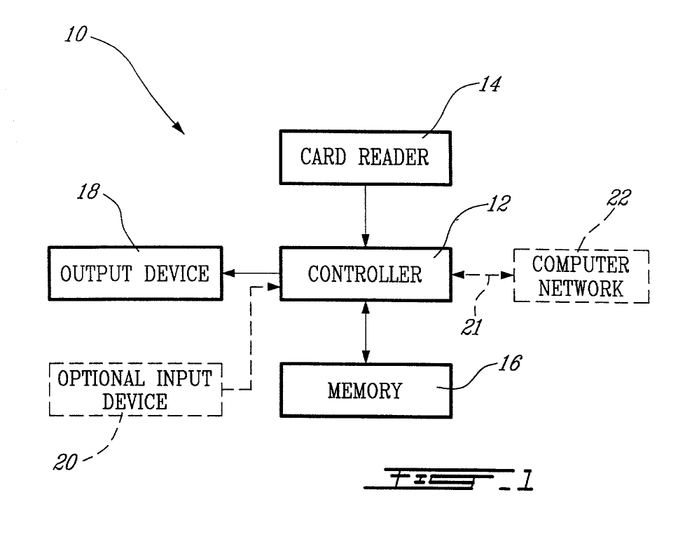

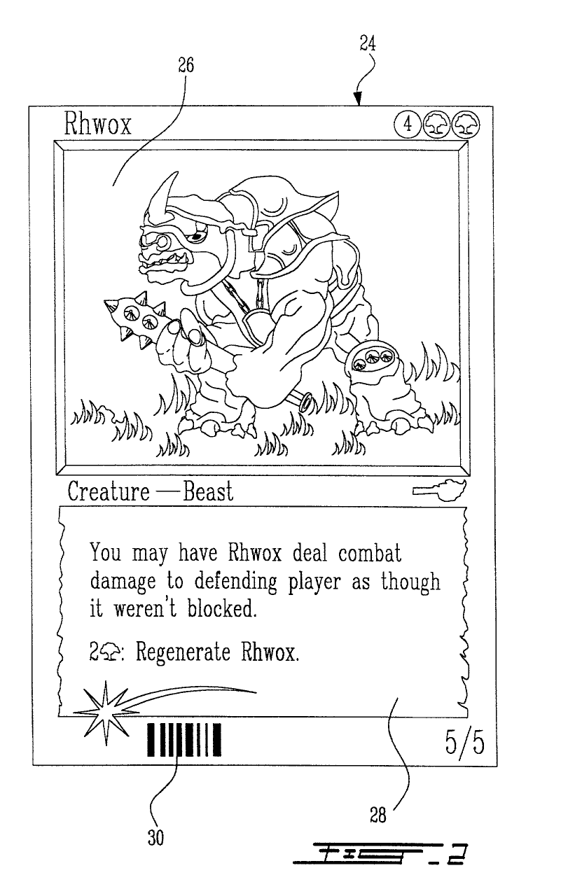

An embodiment of the present invention will now be described with reference to the appended figures. This embodiment includes two major elements: a card reader assembly, as illustrated in FIG. 1, and encoded playing/trading cards, three variations of which are illustrated in FIGS. 2 to 4.

Turning now to FIG. 1 of the appended drawings, a card reader assembly 10 will be described. As it can be seen from this figure, the card reader assembly includes a controller 12 used as the common link between the other elements of the assembly 10, including preferably an output device 18, a card reader 14 and a memory 16.

Optionally, the card reader assembly 10 may also include an input device 20 and/or a connection 21 to a network of computers 22 such as, for example, the Internet, as will be described hereinbelow.

The controller 12 consists in an electronic circuit (not shown) that comprises a processor and ports for connection to the other elements of the assembly 10. Of course, a personal computer provided with adequate software may be used as the controller 12.

The technology used in the card reader 14 varies according to the technology used for the encoding of the data in the playing card. It is believed that one skilled in the art would be in a position to design a card reader compatible with the encoding technology used.

The memory 16 may advantageously comprise a flash memory card and an associated reader connected to the controller 12. As will be described hereinbelow, this allows the use of the card reader assembly 10 with playing/trading cards that are used for different games.

Alternatively, the memory 16 may be a conventional memory, preloaded in a “locked” state by the manufacturer. In this case, a special playing/trading card allows to partially or totally “unlock” the data stored in the memory.

The output device 18 may take many forms depending on the vocation of the card reader assembly 10, as will be described hereinbelow. For example, the output device 18 may take the form of an audio speaker, a computer monitor or any other type of multimedia device.

Depending on the type of game played with the card reader assembly 10, and of the sophistication of the controller 12, an optional input device may also be provided to let the user(s) enter additional data into the controller 12 as will be described hereinbelow.

The optional connection 21 to an external computer network 22 such as, for example, the Internet, is advantageously used to download game rules and store them in the memory 16, or to download special features.

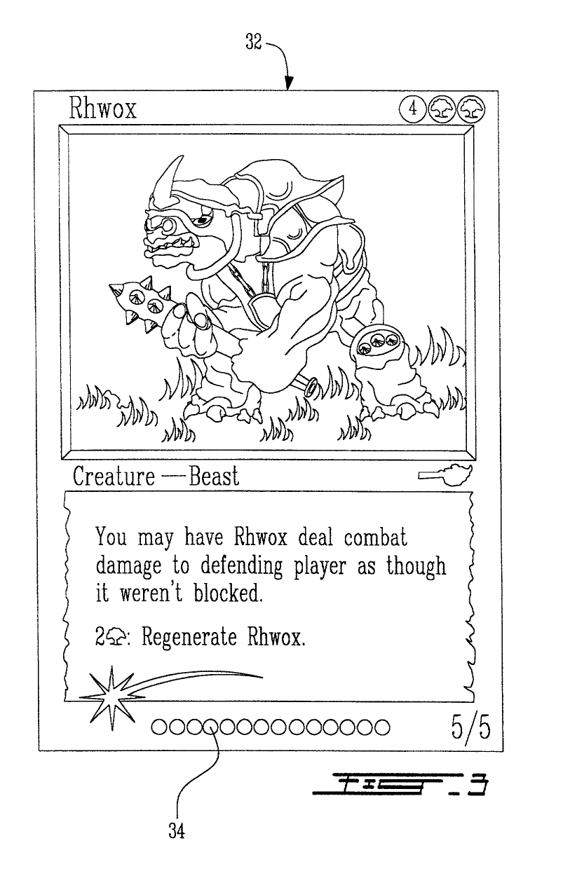

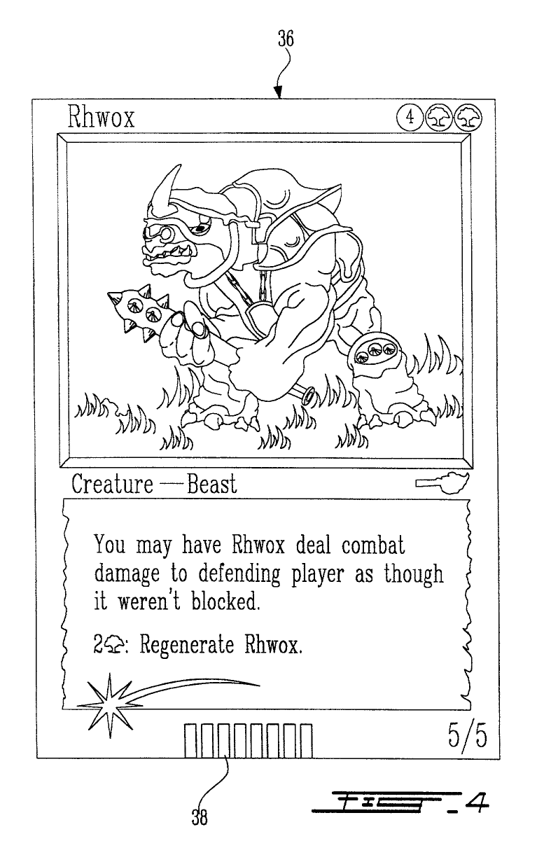

A first embodiment of a playing/trading card 24 will now be described with reference to FIG. 2. It is to be noted that even though the playing card illustrated in FIG. 2 (and similarly in FIGS. 3 and 4 described hereinbelow) are examples of cards from the game called “Magic The Gathering®”, the present invention is not limited to this particular game or even to this particular type of game as will be apparent from the ongoing description. For concision purposes, only this type of playing card will be described herein since one skilled in the art can easily adapt the present description to other types of playing/trading cards.

The playing card 24 is divided into three main parts: an illustration portion 26, which displays an image related to the card; a description portion 28 giving information about the nature of the card; and a portion 30 dedicated for encoding, containing a bar code (or a binary code) that is readable by the card reader 14, which, when this type of coding technology is used, includes a bar code reader.

For illustration purposes, the operation of the system will now be described with reference to the above mentioned game called “Magic The Gathering®”.

Generally stated, the main purpose of the game “Magic The Gathering®” is to build an army of “creatures” devoted to protect the player from attacks launched by the other players. Three main types of cards exist: the land cards (required to cast spells and to summon the creatures); the creature cards (for example, FIG. 2 illustrates a creature card); and the spell cards, which can be used to modify the features of creatures or to deal virtual damage to opponent players. By gathering as many land cards as possible, the players may use those cards to put creatures or spells into play.

As the game begins, each player is allocated a predetermined number of life points. A player looses the game should he run out of life points.

There are many ways to enhance interactivity in this type of game, examples of which will now be described.

A first mode of interactivity consists in having the output device 18, in this case an audio speaker, voice the text included in the description portion 28 of the card 24. To implement such a feature, the memory 16 is loaded with the descriptions of all the possible cards and the controller 12 accesses the portion of the memory 16 corresponding to the particular card 24 introduced in the card reader 14 as determined by the coding of the encoded portion 30, as read by the card reader 14. Various other sounds and special effects may also be associated with the cards to increase the thrill of the gaming experience.

As a possible variation of this first mode, the card reader reads a sequence of cards before the output device plays a message back. For example, if a player puts a creature into play and casts a spell that modifies the features of the creature, the multimedia output device gives a message reflecting these modifications. The interactive message may be an audio signal or a video display, for example.

In a second possible mode of interactivity, the programming of the controller 12 includes the rules of the game and the possible interactions between the different cards. In this mode, the optional input device 20 is advantageously used to indicate to the controller which player is taking a playing turn. Each player can thereby receive advice from the controller in return for disclosure of his hand to the controller, for example. The output device 18 may include separate speakers, such as earphones for example, and the controller may supply personal information to each player. Similarly, the input device 20 may include a keypad for each player.

Alternatively, one card reader assembly is provided for each player. These separate card reader assemblies communicate with one another via their respective computer network interface 21, which may consist in wireless communication links such as infrared communication links. Of course, the game may also be played over a computer network 22.

It is to be noted that this same level of interactivity can be achieved with a conventional card playing deck including 52 cards, provided the cards are modified so as to include a coding thereon. In this case, the controller 12 is provided with the rules of the specific game played and independently provides advice to the players or insures that the rules of the game are strictly followed, for example.

FIG. 3 of the appended drawings illustrates a second embodiment of the playing/trading card 32 similar to the card 24 of FIG. 2. The major difference between these cards relates to the coding thereon. Indeed, instead of having a bar code 30 used to transfer data to the controller, the playing/trading card 32 is provided with a series of encoding color dots 34 used to encode data onto the card. Of course, an adequate card reader 14 must be used.

It is to be noted that even though the encoding color dots 34 are shown as having a color sharply contrasting the background color of the card 32, these dots may advantageously be of about the same color as the background so as to be essentially invisible. Then, an appropriate sensor is used to detect a difference in wavelength between colors that look similar to the eye, for example between inks manufactured by Reiger inks Ltd. under the codes O/S Special Black (Code #MSF468) and O/S PMS Black (Code #31915). The use of such “invisible inks” yields cards that are virtually indistinguishable from conventional playing cards.

Another way of achieving the encoding of the cards while keeping an essentially unchanged card appearance makes use of two different types of varnish having a different reflectivity. In this case, a sensor is needed to differentiate between the reflectivity of these two varnishes. For example, varnishes manufactured by Reiger inks Ltd. under the codes W/B O/B Varnish (Code #WC15408) and W/B O/P Varnish (Code #WC15407) can be used.

An advantage of the embodiments of playing/trading cards illustrated in FIGS. 2 and 3 is that these cards can be produced using conventional printing techniques, therefore causing no increase in the costs of manufacture of the cards.

A third embodiment of a playing/trading card 36 according to another aspect of the present invention is illustrated in FIG. 4. Generally stated, the card 36 is a so-called “smart card”. It includes terminals 38 used to provide electrical connection between the microchip (not shown) of the card and the card reader 14. Accordingly, information and power units can be loaded or stored in the card 36, or deleted therefrom, from game to game. The data is therefore “coded” in the microchip of the card.

More specifically, in this case, the card reader 14 also has some card writing capabilities to thereby enable the controller 12 to modify the data contained in the card's microchip memory (not shown).

By using a card as illustrated in FIG. 4, the introduction of a significant concept, which is character development, is allowed. This would change the game, which is usually “reset” each time it is played, into a game that can span several gaming sessions.

With these “loading”, “reading”, “growing” and “deleting” abilities, the “smart card” technology allows for card/character customization. The players using that interactive card option are able to develop their collection of cards by trading information with friends, or via the Internet.

Even though playing cards such as the cards described hereinabove are often traded, pure trading cards, such as for example sports cards, may greatly benefit from the interactive features of the present invention. For example, when inserted in a card reader 14, a sports card picturing a famous sports player and including encoded data thereon causes the output device 18 to playback a physical description of the famous sports player and/or relate to the highlights of his or her career. Furthermore, provided the card reader assembly includes a link 21 to a computer network, recent highlights can be downloaded and played back and/or recorded in the card, should “smart card” technology be used.

Of course, even though three different technologies have been presented hereinabove to transfer data from an encoded card to a controller, many other techniques may be used. For example, non-contact technologies, such as the transponder technology or various laser-reading technologies, may be used.

It is to be noted that the specific technology used by the card reader assembly 10 varies according to the type of encoding used, the type of game played with the playing/trading cards, for example. Therefore, only the general principles of the card reader assembly have been described herein, for concision purposes. It is however believed to be within the reach of one skilled in the art to design an adequate card reader assembly according to game and data encoding specifications.

Although the present invention has been described hereinabove by way of preferred embodiments thereof, it can be modified, without departing from the spirit and nature of the subject invention as defined in the appended claims.

What is claimed is:

1. An interactive card system comprising:
at least one card provided with encoded data;
a card reader assembly including:
a controller;
a card reader connected to said controller; said card reader being configured to decode the data provided on said at least one card;
memory associated with said controller; said memory being configured to store data relating to said at least one card;
an output device connected to said controller;
wherein said controller is so configured that when the encoded data of one of said at least one card is decoded by said card reader, a corresponding portion of said memory is accessed by said controller and is supplied to said output device.

2. An interactive card system as recited in claim 1, further comprising an input device connected to said controller to enable the user to input data to said controller.

3. An interactive card system as recited in claim 1, further comprising a link to a computer network.

4. An interactive card system as recited in claim 1, wherein said encoded data is in the form of bar code data and wherein said card reader includes a bar code reader.

5. An interactive card system as recited in claim 1, wherein said encoded data is in the form of color-encoded data and wherein said card reader includes a color encoded card reader.

6. An interactive card system as recited in claim 5, wherein said color encoded data is coded via the use of colored dots.

7. An interactive card system as recited in claim 6, wherein said colored dots have essentially similar colors differentiable by a sensor of said card reader.

8. An interactive card system as recited in claim 6, wherein said colored dots are varnished using varnishes having different reflectivity detectable by a sensor of said card reader.

9. An interactive card system as recited in claim 1, wherein each said at least one card includes a microchip and wherein said encoded data is included in said microchip; wherein said card reader includes a microchip reader.

10. An interactive card system as recited in claim 1, wherein said at least one card includes at least one playing card.

11. An interactive card system as recited in claim 1, wherein said at least one card includes at least one trading card.

12. A card reader assembly to read encoded data provided on a card; said assembly comprising:
a controller;
a card reader connected to said controller; said card reader being configured to decode the data encoded on a card;
memory associated with said controller; said memory being configured to store data relating to said card;
an output device connected to said controller;
wherein said controller is so configured that when the encoded data of a card is decoded by said card reader, a corresponding portion of said memory is accessed by said controller and supplied to said output device.

13. A card reader assembly as recited in claim 12, further comprising an input device connected to said controller to enable the user to input data to said controller.

14. A card reader assembly as recited in claim 12, further comprising a link to a computer network.

15. A card reader assembly as recited in claim 12, wherein card reader includes a bar code reader.

16. A card reader assembly as recited in claim 12, wherein said card reader includes a color encoded card reader.

17. A card reader assembly as recited in claim 16, wherein said color encoded card reader may distinguish between different reflectivity varnishes.

18. A card reader assembly as recited in claim 12, wherein said card reader includes a microchip reader.

19. An interactive card system comprising:
at least one card provided with encoded data;
a card reader assembly including:
controlling means;
card reading means connected to said controlling means; said card reading means decoding the data provided on said at least one card;
memory associated with said controlling means to store data relating to said at least one card;
output means connected to said controlling means;
wherein said controlling is so configured that when the encoded data of one of said at least one card is decoded by said card reading means, a corresponding portion of said memory is accessed by said controlling means and supplied to said output means.
